(19) United States
(12) Patent Application Publication
(10) Pub. No.: US 2026/0200794 A1
(43) Pub. Date: Jul. 16, 2026

(54) A PROCESS FOR COATING INTEGRATIVE PATTERNING AND FUNCTIONALIZATION OF GLASS, AND USES THEREOF

(71) Applicants: INDIAN INSTITUTE OF SCIENCE EDUCATION AND RESEARCH, PUNE (IISER PUNE), Pashan, Pune Maharashtra (IN); PILKINGTON TECHNOLOGY MANAGEMENT LIMITED, Lathom, England Lancashire (GB)

(72) Inventors: Satishchandra Balkrishna OGALE, Kothrud, Maharashtra (IN); Mohammad FURQUAN, Dist: Moradabad, Uttar Pradesh (IN); Nikhil KUMAR, Chakradharpur, West Singhbhum Jharkhand (IN); Richa Amod BOBADE, Dange Chowk, Pune Maharashtra (IN); Karikath Sukumar VARMA, Birkdale, Southport Merseyside (GB)

(73) Assignees: INDIAN INSTITUTE OF SCIENCE EDUCATION AND RESEARCH, PUNE (IISER PUNE), Pashan, Pune Maharashtra (IN); PILKINGTON TECHNOLOGY MANAGEMENT LIMITED, Lathom, England Lancashire (GB)

(21) Appl. No.: 19/136,776

(22) PCT Filed: Dec. 8, 2023
(86) PCT No.: PCT/IB2023/062394

§ 371 Date: Jun. 6, 2025

(30) Foreign Application Priority Data
Dec. 8, 2022 (IN) 202221070801

(51) Int. Cl. C03C 23/00; C03C 15/00; C03C 17/00; C03C 17/06; C03C 17/23

(52) U.S. Cl. CPC C03C 23/0025; C03C 15/00; C03C 17/002; C03C 17/06; C03C 17/23; C03C 23/0085; C03C 2217/212; C03C 2217/228; C03C 2217/261; C03C 2217/268

(57) ABSTRACT

The present disclosure pertains to a process of functionalization of glass. Specifically, a process for producing a patterned functional coating over a glass surface. In particular, the present disclosure provides a process for making an integrative, embedded, and non-detachable functionalized powder coating integration onto the glass surface through the CO₂ laser patterned line scan irradiation. The invention also relates to the use of said functionalized glass in various applications.

### FIELD OF THE INVENTION

The present disclosure pertains to a process of functionalization of a glass substrate. Specifically, the process may produce a patterned functional coating over a glass surface. In particular, the present disclosure provides a process that can be utilised for making an integrative, embedded, and non-detachable functionalized powder coating integration onto the glass surface through the CO₂ laser patterned line scan irradiation. The invention also relates to the use of said functionalized glass substrate in various applications such as energy storage glass, keeping the room warm or cool depending upon material integrated into the glass, integration of electrical wiring and connection, reflection and absorption of specific radiation, magnetics, spintronics, advanced sensors, actuators, and the like.

### BACKGROUND OF THE INVENTION

The background description includes information that may be useful in understanding the present invention. It is not an admission that any of the information provided herein is prior art or relevant to the present invention, or that any publication specifically or implicitly referenced is prior art.

Glass is traditionally a building material or a passive support material in several technological applications. There are some cases when glass is doped at its formative stage by specific elements to render it functional. Laser engraving of glass is also performed for different applications using lasers of different wavelengths.

However, there have been few attempts to process glass surface layers using different forms of energy processing whereby functional materials of interest to emergent technologies can be directly surface-incorporated into glass surface layers.

In fact, incorporative and reactive integration of such materials onto the surface layers of glass can generate entirely new materials and phases with compositions, structures and properties that have not been realized hitherto.

This has the potential to dramatically open-up and enhance the applicability of prefabricated glass, which is otherwise used as a passive support material, into application domains such as energy, magnetics, spintronics, advanced sensors, and actuators and the like.

Therefore, herein we disclose the development of a process that enables to expand the application horizons of glass by its synergistic incorporative and reactive integration with other functional materials, especially in their powder form.

### OBJECTS OF THE INVENTION

Objects of the present invention are to provide a process for functionalization of a glass substrate.

An object of the present invention is to provide a process for producing a patterned functional coating over a glass surface.

Another object of the present invention is to provide a process for making an integrative, embedded, and non-detachable functionalized powder coating integration onto the glass surface through the CO₂ laser patterned line scan irradiation.

Yet another object of the present invention is to provide a functionalized glass by the process disclosed herein for various applications.

### SUMMARY OF THE INVENTION

This summary is provided to introduce a selection of concepts in a simplified form that are further described below in Detailed Description section. This summary is not intended to identify key features or essential features of the claimed subject matter, nor is it intended to be used as an aid in determining the scope of the claimed subject matter.

In one aspect, there is provided a process of manufacturing a functionalized glass substrate, comprising the following steps in order:
i) providing a glass substrate,
ii) etching a surface of the glass substrate to form an etched surface,
iii) contacting at least part of the etched surface with a material,
iv) lasering said part of the etched surface and/or said material, thereby forming a functionalized glass substrate that
(a) incorporates said material or a derivative thereof within said glass substrate, and/or
(b) comprises a coating of said material or a derivative thereof on said part of the etched surface.

It has surprisingly been established that the process of the present invention can deliver incorporative as well as reactive integration of materials within a glass substrate.

The etching of a surface of the glass substrate in step ii) may be carried out by lasering and/or chemical treatment, preferably by lasering.

When present, the lasering of step ii) may be carried out using a gas laser, a chemical laser, a dye laser, a metal-vapour laser, a solid-state laser and/or a semiconductor laser. Preferably, when present, said lasering of step ii) is carried out using a gas laser such as a xenon ion laser, nitrogen laser, krypton laser, helium-neon laser, excimer laser, carbon monoxide laser, carbon dioxide laser and/or argon laser. Most preferably, when present, said lasering of step ii) is carried out using a carbon dioxide laser. Said carbon dioxide laser preferably emits at 9-11 μm, more preferably at 10.6 μm.

When present, the lasering of step ii) may be carried out using a laser power of from 1 to 50 W, more preferably from 1 to 40 W, even more preferably from 1 to 30 W. When present, the lasering of step ii) may be carried out using a laser scan speed of from 1 mm/s to 10000 mm/s, more preferably from 1 mm/s to 5000 mm/s, even more preferably from 1 mm/s to 1000 mm/s, most preferably from 10 mm/s to 500 mm/s. Said lasering may be carried out in continuous wave, pulsed, scanning or any other suitable mode.

The lasering of step iv) may be carried out using a gas laser, a chemical laser, a dye laser, a metal-vapour laser, a solid-state laser and/or a semiconductor laser. Preferably, said lasering of step iv) is carried out using a gas laser such as a xenon ion laser, nitrogen laser, krypton laser, helium-neon laser, excimer laser, carbon monoxide laser, carbon dioxide laser and/or argon laser. Most preferably, said lasering of step iv) is carried out using a carbon dioxide laser. Said carbon dioxide laser preferably emits at 9-11 μm, more preferably at 10.6 μm.

The lasering of step iv) may be carried out using a laser power of from 1 to 50 W, more preferably from 1 to 40 W, even more preferably from 1 to 30 W. The lasering of step iv) may be carried out using a laser scan speed of from 1 mm/s to 10000 mm/s, more preferably from 1 mm/s to 5000 mm/s, even more preferably from 1 mm/s to 1000 mm/s, most preferably from 10 mm/s to 500 mm/s. Said lasering may be carried out in continuous wave, pulsed, scanning or any other suitable mode.

When present, the chemical treatment of step ii) may be carried out using hexafluorosilicic acid, hydrogen fluoride, hydrofluoric acid, sodium fluoride, and/or ferric chloride.

The etching of a surface of the glass substrate in step ii) may form a pattern on the surface of the glass substrate. Preferably the pattern comprises parallel lines, more preferably a grid.

Preferably the material of step iii) is in the form of a solid, more preferably a powder, or a film attached to said part of the etched surface. When the material of step iii) is in the form of a film attached to said part of the etched surface, preferably said film has been deposited as a liquid and then dried to form a solid film, e.g. via spray pyrolysis, chemical bath deposition or sol-gel techniques. Alternatively, the film may have been deposited via other suitable methods such as chemical vapour deposition, plating, sputtering or evaporation techniques.

The material of step iii), and/or the material or derivative thereof incorporated within said glass substrate in step iv), and/or the material or derivative thereof of the coating on said part of the etched surface in step iv) may comprise particles with a z-average diameter in accordance with ISO 22412:2017 of at least about 1 nm, 10 nm, 50 nm, 100 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2500 nm, 3000 nm, 4000 nm, 5000 nm, 6000 nm, 7000 nm, 8000 nm, or at least 9000 nm. In some embodiments, the particles may have a z-average diameter in accordance with ISO 22412:2017 of less than 10,000 nm, 9000 nm, 8000 nm, 7000 nm, 6000 nm, 5000 nm, 4500 nm, 4000 nm, 3500 nm, 3000 nm, 2500 nm, 2000 nm, 1900 nm, 1800 nm, 1700 nm, 1600 nm, 1500 nm, 1400 nm, 1300 nm, 1200 nm, 1100 nm, 1000 nm, 900 nm, 800 nm, 700 nm, 600 nm, 500 nm, 250 nm, or less than 100 nm. The z-average diameter of said particles can range from any of the minimum values described above to any of the maximum values described above, for example from 1 nm to 10,000 nm, 50 nm to 5,000 nm, 100 nm to 2500 nm, 200 nm to 2000 nm, or 500 nm to 1000 nm.

The material of step iii), and/or the material or derivative thereof incorporated within said glass substrate in step iv), and/or the material or derivative thereof of the coating on said part of the etched surface in step iv) may comprise inorganic materials, polymers, organic molecules, organic-inorganic hybrid materials etc. or any combinations thereof. Preferably the material comprises one or more metal, metal oxide, nitride (e.g. TiN, BN, etc.), sulfide (e.g. MOS₂, BaS, etc.), and/or halide e.g. chloride (NaCl, CuCl, CoCl, etc.) or bromide (CuBr, etc.). The material may comprise one or more of Fe, Mn, Ni, Sn, Zn, Fe₂O₃, TiO₂, Ag₂O, LCO (lithium cobalt oxide), NaWO₄, ZrO₂, TiN, BN, CuO, CuCl, CuBr, NaCl, CoCl, BaS and/or MoS₂. The material may comprise a mixture of materials e.g. the material may comprise Fe and CuCl, or TiO₂ and CuCl, or TiO₂ and Sn, or TiO₂ and BN, or NaCl and Ni. The material can be a combination of metal, oxides, nitrides, sulfides etc. and is not limited to those given above but can also include a broad range of other classes (e.g., superconducting materials, thermoelectric materials, polymeric materials, and the like.).

Preferably in step iii) the material is provided as a layer on the etched surface. Preferably the material contacts at least 50%, more preferably 70%, even more preferably 90%, even more preferably substantially all, most preferably all of the etched surface. In some embodiments the layer may be provided in distinct regions of the etched surface, for example in regions where etching has occurred. Preferably said layer of material on the etched surface has a thickness of from 10 μm to 100 μm, more preferably from 1 nm to 10 μm.

Said material or a derivative thereof incorporated within said glass substrate is, when viewed normal to the etched surface of the glass substrate, preferably located up to 50 μm from said etched surface, more preferably up to 25 μm from said etched surface, even more preferably up to 20 μm from said etched surface, most preferably between up to 20 μm and up to 10 μm from said etched surface. Said material or a derivative thereof incorporated within said glass substrate may form a gradient in terms of its frequency when moving from the etched surface normal to said etched surface.

The lasering of step iv) may result in reduction of the material.

The process may be carried out in an air atmosphere or an inert atmosphere.

Preferably step iv) further comprises sonication of the functionalized glass substrate. Said sonication may be carried out in suitable organic or aqueous solvent. Preferably, following sonication of the functionalized glass substrate, the functionalized glass substrate is dried, preferably using a hot air blower or an oven.

In one embodiment, the present disclosure relates to a process for functionalization of glass substrate surface effected by CO₂ laser (wavelength 10.6 μm) based direct-write patternable transient photothermal process in scanning mode (x, y or x and y) for integrative and reactive incorporation of a powder coated layer on the surface of a glass.

In one embodiment of the present disclosure, the powder is spread on the etched glass surface rather than by the conventional cladding process, which involves a precursor material pumped from a nozzle for cladding.

In one embodiment of the present disclosure, the solution provided by the invention is in the form of scanned CO₂ laser beam processing of glass surface coated with one or more functional materials, whereby the transient heat pulse rendered by the scanned laser beam delivers on the incorporative as well as reactive integration of the two.

In yet another embodiment of the present disclosure, the derivative of the functionalized glass substrate may have different properties (e.g., electronic, chemical, and mechanical) compared to the material.

Preferably said surface of the glass substrate is a major surface of the glass substrate. Preferably the glass substrate is transparent. The glass substrate may be a clear metal oxide-based glass pane. Preferably the glass pane is a clear float glass pane, preferably a low iron float glass pane. By clear float glass, it is meant a glass having a composition as defined in BS EN 572-1 and BS EN 572-2 (2004). For clear float glass, the Fe₂O₃ level by weight is typically 0.11%. Float glass with an Fe₂O₃ content less than about 0.05% by weight is typically referred to as low iron float glass. Such glass usually has the same basic composition of the other component oxides i.e. low iron float glass is also a soda-lime-silicate glass, as is clear float glass. Typically, low iron float glass has less than 0.02% by weight Fe₂O₃. Alternatively, the glass pane is a borosilicate-based glass pane, an alkali-aluminosilicate-based glass pane, or an aluminium oxide-based crystal glass pane.

According to a second aspect of the present invention there is provided the use of the functionalized glass substrate manufactured according to the process of the first aspect in architectural, automotive or electronic applications, e.g. in a glazing frame, wall, bulkhead, blind, door, electronic device such as a PV module, liquid-crystal display or OLED, a touchscreen, mirror, container, furniture, splashback, vehicle window, energy storage glass, electrical connector, sensor, actuator, in magnetics, and/or spintronics.

Various objects, features, aspects and advantages of the inventive subject matter will become more apparent from the following detailed description of preferred embodiments.

### BRIEF DESCRIPTION OF DRAWINGS

Characteristics and advantages of the subject matter as disclosed in the present disclosure will become clearer from the detailed description of an embodiment thereof, with reference to the attached drawing, given purely by way of an example, in which:

FIG. 1A: Flow chart of a process according to the present invention.

FIG. 1B: A glass substrate etched along x and y directions by CO₂ laser line scan; FIG. 1C: etched glass substrate and integrated film in-plane interface region (top view or surface view).

FIG. 2: XRD of integratively fused Fe powder coating on glass surface.

FIG. 3: FE-SEM image of embedded or integratively functionalized Fe powder coating after irradiation of CO₂ laser.

FIG. 4: XRD of silver oxide powder coating on the glass surface treated with CO₂ laser. The powder has converted to a nano-silver film.

FIG. 5: FESEM morphology: Nano-silver film from Ag₂O powder on glass.

FIG. 6: XRD analysis reveals the oxygen vacancy defect-rutile (black) phase film formation from the starting anatase TiO₂.

FIG. 7: FESEM image of rutile TiO₂ film on the glass surface.

FIG. 8: XRD of laser processed Sn powder coating showing formation of mixed phase of Sn and SnO₂.

FIG. 9: FESEM analysis reveals formation of continuous, and dense film of Sn and SnO₂ from Sn powder through CO₂ laser treatment.

FIG. 10: XRD of the integratively incorporated Fe₃O₄ black film on glass surface by CO₂ laser processing of hematite (Fe₂O₃) coated glass.

FIG. 11: XRD of copper (I) oxide (Cu₂O) coating generated from copper (II) oxide (CuO) powder coating on glass via CO₂ laser treatment.

### DETAILED DESCRIPTION OF THE INVENTION

The following is a detailed description of embodiments of the disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some embodiments, numbers have been used for quantifying weight percentages, angles, and so forth, to describe and claim certain embodiments of the invention and are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Various terms as used herein are shown below. To the extent a term used in a claim is not defined below, it should be given the broadest definition persons in the pertinent art have given that term as reflected in printed publications and issued patents at the time of filing.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context requires otherwise, throughout the specification which follow, the word “comprise” and variations thereof, such as, “comprises” and “comprising” are to be construed in an open, inclusive sense that is as “including, but not limited to.”

The recitation of ranges of values herein is merely intended to serve as a shorthand method of referring individually to each separate value falling within the range. Unless otherwise indicated herein, each individual value is incorporated into the specification as if it were individually recited herein. In the discussion of the invention herein, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified.

The description that follows, and the embodiments described therein, is provided by way of illustration of an example, or examples, of particular embodiments of the principles and aspects of the present disclosure. These examples are provided for the purposes of explanation, and not of limitation, of those principles and of the disclosure.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Various terms are used herein. To the extent a term used in a claim is not defined below, it should be given the broadest definition persons in the pertinent art have given that term as reflected in printed publications and issued patents at the time of filing.

In the context of the present invention a “derivative” is a chemical substance related structurally to another chemical substance and theoretically derivable from it.

In the context of the present invention the “thickness” of a layer is, for any given location at a surface of the layer, represented by the distance through the layer, in the direction of the smallest dimension of the layer, from said location at a surface of the layer to a location at an opposing surface of said layer.

While a particular form of the invention has been illustrated and described, it will be apparent that various modifications can be made without departing from the spirit and scope of the invention.

Embodiments of the present disclosure pertain to a process for producing a patterned functional coating for a glass layer. In particular, the present disclosure provides a process for making an integrative, embedded, and non-detachable functionalized powder coating integration onto the glass surface through the CO₂ laser patterned line scan irradiation. The invention also relates to the use of said functionalized glass in various applications.

In an embodiment, the solution provided by the disclosure is in the form of scanned CO₂ laser beam processing of glass surface coated with one or more functional materials, whereby the transient heat pulse rendered by the scanned laser beam delivers incorporative as well as reactive integration of the two. This approach concurrently heats up both the glass surface and the coated powder material to enable and forge the rapid diffusive incorporation of and reaction between the species. The “incorporative” part further distinguishes this invention from the commonly employed surface coating approach wherein the glass and the coating maintain their own identities and properties.

In one embodiment of the present disclosure, the functionalization is effected by CO₂ laser (wavelength 10.6 μm) based direct-write patternable transient photothermal process in scanning mode (x, y or x and y) for integrative and reactive incorporation of a powder coated layer on the surface of a glass.

In one embodiment of the present disclosure, the CO₂ laser power and scan speeds can be in the range from 1 W to 30 W and 1 mm/s to 1000 mm/s, respectively, but not limited to these windows.

According to the present embodiment, an integratively and/or reactively bonded uniform or patterned coating can be realized on the glass surface with various types of material powders such as powders of metals, metallic oxides, nitrides, carbides, chlorides, sulfides, and the like. Furthermore, mixed powders of metal to metal oxides, chloride, nitrides, sulfides, and the like, can also be integrated into the glass surface rendering the possibilities of obtaining engineered application-worthy compound or composite layers on the surface. The combination of powders can be broad; for example, mixing metal/semi-metal oxides, oxide with another oxide, metal with another metal, oxide with nitride or chloride, and the like. The thickness (or thicknesses) of the materials (the layers of materials) used as coatings before the laser treatment dictate the laser energy density and scan speeds to achieve a desirable set of properties and the gradients of materials constitution as a function of depth.

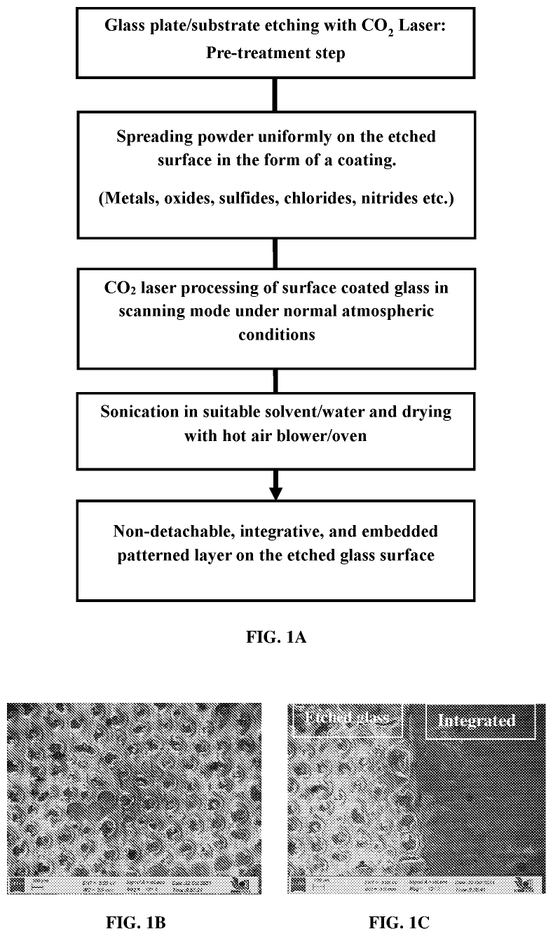

As stated above, a process according to the present invention is shown as a flow chart in FIGS. 1A and 1s comprised of the steps of: patterned etching of glass surface through CO₂ laser followed by uniform spreading of the desired precursor powder coating, and again laser irradiation of the coated surface (without any medium except atmosphere air/environment) in a line scanning mode in single or multiple scan modes in the x and/or y directions with or without or partial scan overlaps under normal atmospheric conditions. The process may further include the steps of sonication of the functionalized glass in suitable solvent/water, followed by drying with hot air blower/oven. The precursor powder is chosen from materials that are metallic/metallic oxides, nitrides, sulfides, and chlorides and/or their combinations. The CO₂ laser usage in scanning mode is important since it imparts transient heating at any local spot, and the laser itself could be operated in CW or pulsed modes rendering different results in terms of final material obtained and its properties.

In one embodiment of the present disclosure, the powder is spread on the etched glass surface rather than by the conventional cladding process, which involves a precursor material pumped from a nozzle for cladding, although cladding can be utilised in alternative embodiments.

The mixed powder coatings can have two or multiphase materials, i.e., two, three, four, or more different materials. The ratio of mixing powder ‘1’ to powder ‘2’ can also be broad, for example, starting from less than 1% to more than 99%. Similarly, coating of mixed multiple powders (e.g., mixing of two, three, four, and the like) can have any range of mixing percentage depending upon the desired feature and material properties.

A few of the examples have been given in table 1 and are used in the examples below.

TABLE 1
Various types of powders used for integrative
glass processing using CO₂ laser scanning.

| Powder | Mixed powder |
|---|---|
| Fe | Fe + CuCl |
| Mn | TiO₂ + CuCl |
| Ni | TiO₂ + Sn |
| Sn | TiO₂ + BN |
| Zn | NaCl + Ni |
| Fe₂O₃ | |
| TiO₂ | |
| Ag₂O | |
| LCO (lithium | |
| cobalt oxide) | |
| NaWO₄ | |
| ZrO₂ | |
| TiN | |
| Boron nitride (BN) | |
| CuO | |
| CuCl | |
| CuBr | |
| NaCl | |
| CoCl | |
| BaS | |
| MoS₂ | |

The laser power and scan rate can be tuned in any range from 1 W to 30 W and 1 mm/s to 1000 mm/s representing the parameters of our laser system, however parameters outside this range are also allowable. The etching depth can be tuned, depending upon the desired material film thickness with laser power, speed, and several scans in the X-axis and Y-axis direction.

After CO₂ laser treatment, the formed film can have different or similar properties (e.g., electronic, chemical, and mechanical) compared to the pristine powder(s). Therefore, mixing powders, selection of laser power, and speed enable tuning of the electronic property, morphology, surface area, and change in phase formation, magnetic property, and many more as per the requirement of various applications.

While the disclosure primarily focusses on room temperature (stage temperature) processing under ambient atmospheric conditions, it is not limited to or by these conditions. Also, the invention does not exclude the use of organics or hybrid systems as co-components such as small molecules, polymers, organic-inorganic hybrids etc.

In another embodiment of the present disclosure, the process can be adopted in such way that the integrative film on the glass surface generated by the stated process gets functionalized and can be designed to have the optimum properties such as conductivity, surface texture.

In another embodiment of the present disclosure, the properties such as electronic, magnetic, chemical, electrochemical, solar, fluorescent, and the like, of the integrated film on the glass surface can be tuned via the choice of material powder and their combinations, laser power, and scan speed.

In another embodiment of the present disclosure, the integrated film on the glass surface cannot be easily removed, for example via sonication or scratching via any complex tool (e.g., spatula).

In another embodiment of the present disclosure, the color and texture of the integrated film may change depending upon the coating material properties, and the strength and nature of interaction with the glass, depending upon the laser power, speed, and properties.

In yet another embodiment of the present disclosure, the integrated film on the glass via CO₂ laser can be magnetized through the choice of selected precursor powder (e.g., Fe).

In yet another embodiment of the present disclosure, the integrative film can have different properties from the precursor powder/combination powder and glass via CO₂ laser irradiation, e.g. phase formations that are different from the precursor powder material or glass, and different oxidation states of the film can differ from those in the precursor powder because of direct CO₂ laser exposure to the same.

In one embodiment of the present disclosure, the integrative film can have nano-structural features following CO₂ laser exposure to the precursor powder coating on the glass surface. The film thickness can be tuned from nanometer to few tens of micrometers.

In an embodiment of the present invention, the coating may have a thickness ranging in the nanometre to micro-meter. In some embodiments, the coating may have a thickness of at least about 1 nm, 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 150 nm, 200 nm, 250 nm, 300 nm, 400 nm, 500 nm, 600 nm, or 1000 nm. In some embodiments, the coating may have a thickness of at most about 5000 nm (5 μm), 10 μm, 15 μm, 20 μm, 25 μm, or 50 μm. The thickness can range from any of the minimum values described above to any of the maximum values described above, for example from 1 nm to 20 μm, 500 nm to 20 μm, 1 μm to 20 μm, 2 μm to 20 μm, 5 μm to 20 μm, or 10 μm to 20 μm.

In an embodiment of the present invention, the integrative film comprises “nanoparticles” having sizes ranging in the nanometer scale. However, many particles have wider ranges of sizes. In some embodiments, the material of step iii), and/or the material or derivative thereof incorporated within said glass substrate in step iv), and/or the material or derivative thereof of the coating on said part of the etched surface in step iv) may comprise particles with a z-average diameter in accordance with ISO 22412:2017 of at least about 1 nm, 10 nm, 50 nm, 100 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2500 nm, 3000 nm, 4000 nm, 5000 nm, 6000 nm, 7000 nm, 8000 nm, or at least 9000 nm. In some embodiments, the particles may have a z-average diameter in accordance with ISO 22412:2017 of less than 10,000 nm, 9000 nm, 8000 nm, 7000 nm, 6000 nm, 5000 nm, 4500 nm, 4000 nm, 3500 nm, 3000 nm, 2500 nm, 2000 nm, 1900 nm, 1800 nm, 1700 nm, 1600 nm, 1500 nm, 1400 nm, 1300 nm, 1200 nm, 1100 nm, 1000 nm, 900 nm, 800 nm, 700 nm, 600 nm, 500 nm, 250 nm, or less than 100 nm. The z-average diameter in accordance with ISO 22412:2017 of particles can range from any of the minimum values described above to any of the maximum values described above, for example from 1 nm to 10,000 nm, 50 nm to 5,000 nm, 100 nm to 2500 nm, 200 nm to 2000 nm, or 500 nm to 1000 nm.

In yet another embodiment, the present invention can be used for various applications such as energy storage glass, keeping the room warm or cool depending upon material integrated into the glass, integration of electrical wiring and connection, reflection and absorption of specific radiation, magnetics, spintronics, advanced sensors, actuators, and the like.

While the foregoing description discloses various embodiments of the disclosure, other and further embodiments of the invention may be devised without departing from the basic scope of the disclosure. The invention is not limited to the described embodiments, versions or examples, which are included to enable a person having ordinary skill in the art to make and use the invention when combined with information and knowledge available to the person having ordinary skill in the art.

### EXAMPLES

The present disclosure is further explained in the form of following examples. However, it is to be understood that the foregoing examples are merely illustrative and are not to be taken as limitations upon the scope of the invention. Various changes and modifications to the disclosed embodiments will be apparent to those skilled in the art. Such changes and modifications may be made without departing from the scope of the invention.

### Reagents and Instruments

### Example 1: Functionalization of Glass Surface

Glass slides with dimensions of 7.5 cm×2.5 cm were used in the examples and etched with predefined laser power and scan speed over dimensions of 2.5 cm×1.5 cm in X-axis and Y-axis directions to form a grid pattern.

In each experiment, the etched surface was coated with a single powder or combination of powders and spread uniformly over the etched surface, as desired.

In the examples, a glass slide was initially etched with CO₂ laser along X-axis and Y-axis directions with a nominal laser power of 6 W and a scan rate of 50 mm/s (FIG. 1B). Other scan rates and powers are possible.

A glass slide with powder spread over the etched surface was placed at the focus of the CO₂ laser beam. The powder coated glass surface was irradiated directly with the CO₂ laser. The irradiation power and laser scan rate were tuned in the range of 1-30 W and 1 mm/s-1000 mm/s defining the parametric limits of the laser, although use of parameters outside these bounds is feasible as well. More specifically, 3-6 W laser power and 15-100 mm/s scan speed were used in the X-axis direction for the examples presented, although it could be performed in both directions, in other pattern forms etc. with slightly different effects.

After irradiation of the powder coated glass surface a strongly adherent coating was obtained with pattern (direct-write) formed, as desired (FIG. 1C, right part). The glass slide was then subjected to sonication to remove residues of pristine material in the range of 5-15 min. and washed in water/solvent, followed by a drying step in hot air blower or vacuum oven. The obtained film was intact with the glass surface strongly, even after sonication or scratching of the film.

### Example 2

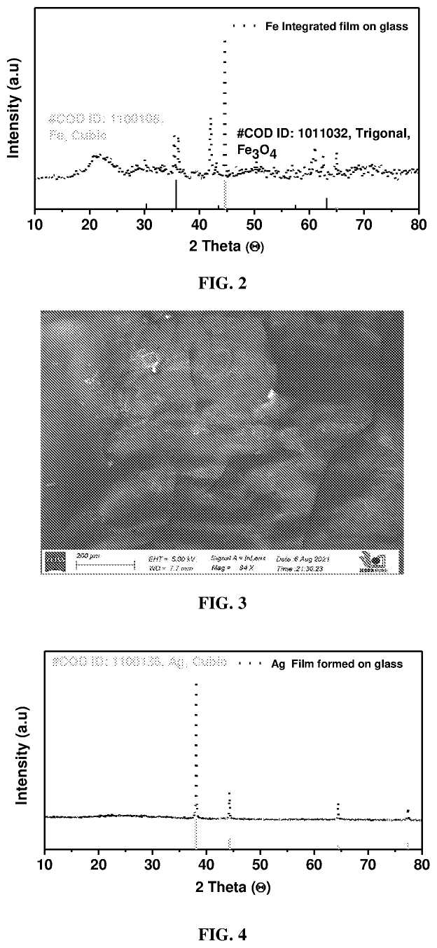

Iron (Fe) powder was spread onto an etched glass surface as a coating and the surface was scanned in X-axis direction with laser power of 6 W and speed of 30 mm/s; which resulted in the Fe particles being integrated into the glass surface. The XRD of the integrative Fe film on glass is presented in FIG. 2 below. It is observed that the integrated film has a mixed phase of Fe and Fe₃O₄. The embedded or integrative coating on glass was found to be highly attracted toward an external magnet from both sides (i.e., opposite and same face of the film on the glass, as expected for a fairly strong and fairly thick magnetic coating even on one side). It is noted post-processing the film is highly uniform and fairly planar, as revealed in the FESEM analysis (FIG. 3).

### Example 3

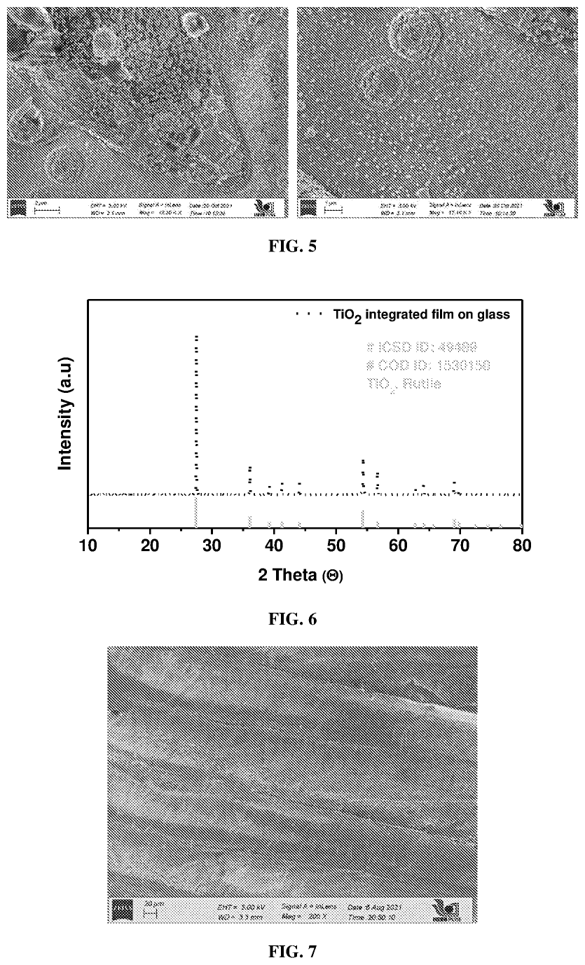

Silver oxide powder was coated on an etched glass surface (e.g., 6 W, 50 mm/s, scanned in X-axis and Y-axis direction) and was then irradiated directly with a CO₂ laser at laser power of 6 W in the X-axis direction with a scan speed of 50 mm/s. It is noted that the black silver oxide powder transformed to an integrative film of orange/light brown color via CO₂ laser treatment. Interestingly, the XRD (FIG. 4) of the processed coating on glass revealed the formation of the silver metal phase from the silver oxide. This implies that the process has intrinsically a reducing nature. The film is found to be comprised of nano-silver particles and distributed thoroughly over the glass surface (FIG. 5) and also within the glass.

### Example 4

A white anatase TiO₂ powder coating was applied on the CO₂ laser pre-treated glass (pretreatment at 6 W, 50 mm/s, scanned in X and Y directions). A CO₂ laser with a power of 4.5-6 W and the X-axis scan speed of 40-60 mm/s was used to irradiate the coated surface. A black colored (implying oxygen vacancy defect-stabilized) TiO₂ rutile phase was found to be integrated into the glass surface as confirmed by the XRD (FIG. 6). FESEM analysis reveals that the grown film is highly dense with a uniform and flat (planar) texture (FIG. 7).

### Example 5

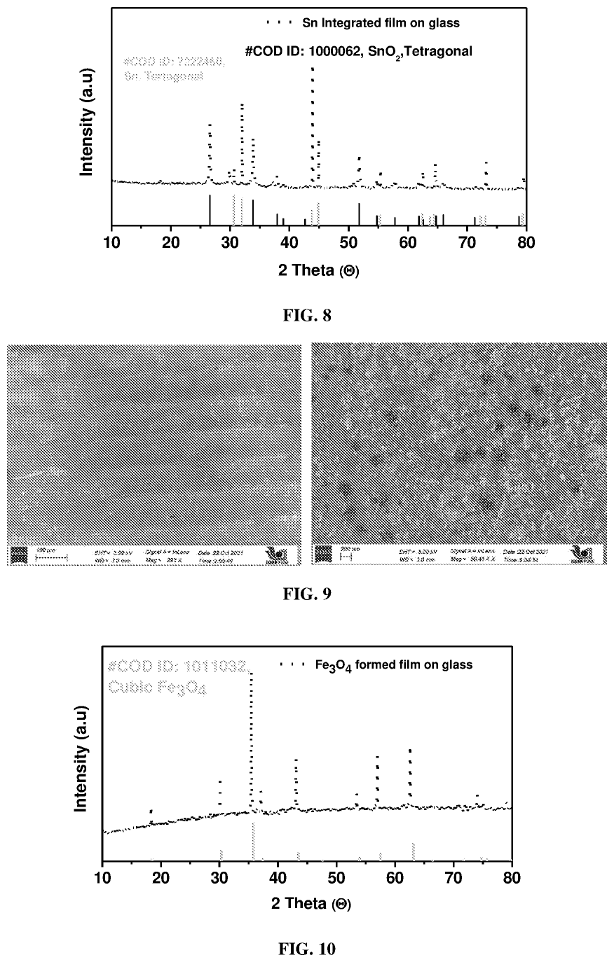

Sn (Tin) powder coating was applied on the etched (as before) glass surface and scanned in X-axis direction with laser power and speed of 6 W, 50 mm/s. This resulted in a shiny green integrated coating on the glass surface. The coating was found to be made up of Sn and SnO₂ phases, as confirmed from the XRD (FIG. 8). The morphology was found to be highly uniform, and sheet-like (FIG. 9). On much smaller scale (right) sheet-type morphology appears to be present at the surface. It is noted here that the film is continuous over the glass surface and is electrically conducting, although not with very high conductivity. Post-processing could potentially change the property parameters.

### Example 6

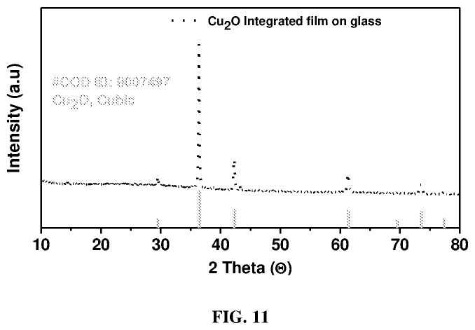

Hematite (alpha-Fe₂O₃) Powder coating processed by CO₂ laser gives integrated Fe₃O₄ ferromagnetic coating when a laser with the power 6 W and scan speed of 50 mm/s is scanned in X-axis direction. The Fe₂O₃ powder has a red color, which changes into a black Fe₃O₄ magnetic film on the surface of glass and also within the glass via the CO₂ laser treatment. This again emphasizes the reducing character of the process, as stated before. (FIG. 10).

### Example 7

Copper (II) oxide or cupric oxide (CuO) powder coating (black color) was applied on the etched glass surface and irradiated with a CO₂ laser power of 6 W irradiation in the X-axis direction at a scan rate of 30/40 mm/s. A golden/brown integrative film comprising Cu₂O or copper (I) oxide (cuprous oxide) was noted to form on the glass substrate, further emphasizing the reducing character of the process. (FIG. 11).

Various modifications and variations of the described assays, techniques and various means disclosed herein to implement the assays/methods in accordance with the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

1. A process of manufacturing a functionalized glass substrate, comprising the following steps in order:
i) providing a glass substrate,
ii) etching a surface of the glass substrate to form an etched surface,
iii) contacting at least part of the etched surface with a material, and
iv) lasering said part of the etched surface and/or said material, thereby forming a functionalized glass substrate that
(a) incorporates said material or a derivative thereof within said glass substrate, and/or
(b) comprises a coating of said material or a derivative thereof on said part of the etched surface.

2. The process according to claim 1, wherein the etching of a surface of the glass substrate in step ii) is carried out by lasering and/or chemical treatment, preferably by lasering.

3. The process according to claim 1, wherein the lasering of step iv), and/or, when present, the lasering of step ii), is carried out using a gas laser selected from a xenon ion laser, nitrogen laser, krypton laser, helium-neon laser, excimer laser, carbon monoxide laser, carbon dioxide laser and/or argon laser, preferably a carbon dioxide laser.

4. The process according to claim 1, wherein the lasering of step iv), and/or, when present, the lasering of step ii), is carried out using a laser power of from 1 to 50 W, preferably from 1 to 40 W, more preferably from 1 to 30 W.

5. The process according to claim 1, wherein the lasering of step iv), and/or, when present, the lasering of step ii), is carried out using a laser scan speed of from 1 mm/s to 10000 mm/s, preferably from 1 mm/s to 5000 mm/s, more preferably from 1 mm/s to 1000 mm/s, most preferably from 10 mm/s to 500 mm/s.

6. The process according to claim 1, wherein the lasering of step iv), and/or, when present, the lasering of step ii), is carried out using a carbon dioxide laser that emits at 9-11 μm, preferably at 10.6 μm.

7. The process according to claim 1, wherein the lasering of step iv) and/or, when present, the lasering of step ii), is carried out in continuous wave, pulsed, and/or scanning mode.

8. The process according to claim 1, wherein the lasering of step iv) and/or, when present, the lasering of step ii), is carried out in an air atmosphere or an inert atmosphere.

9. The process according to claim 2, wherein, when present, the chemical treatment of step ii) is carried out using hexafluorosilicic acid, hydrogen fluoride, hydrofluoric acid, sodium fluoride, and/or ferric chloride.

10. The process according to claim 1, wherein the material of step iii) is in the form of a solid, preferably a powder.

11. The process according to claim 1, wherein the material of step iii), and/or the material or derivative thereof incorporated within said glass substrate in step iv), and/or the material or derivative thereof of the coating on said part of the etched surface in step iv) comprises particles with a z-average diameter in accordance with ISO 22412:2017 of from 1 nm to 10,000 nm, preferably from 50 nm to 5,000 nm, more preferably from 100 nm to 2500 nm, even more preferably from 200 nm to 2000 nm, most preferably from 500 nm to 1000 nm.

12. The process according to claim 1, wherein the material of step iii), and/or the material or derivative thereof incorporated within said glass substrate in step iv), and/or the material or derivative thereof of the coating on said part of the etched surface in step iv) comprises one or more metal, metal oxide, nitride, sulfide, and/or halide e.g. chloride or bromide.

13. The process according to claim 1, wherein the material of step iii), and/or the material or derivative thereof incorporated within said glass substrate in step iv), and/or the material or derivative thereof of the coating on said part of the etched surface in step iv) comprises one or more of Fe, Mn, Ni, Sn, Zn, Fe₂O₃, TiC, Ag2O, LCO (lithium cobalt oxide), NaW04, ZrO₂, TiN, BN, CuO, CuCl, CuBr, NaCl, CoCi, BaS and/or MoS2.

14. The process according to claim 1, wherein, when present, the material or a derivative thereof incorporated within said glass substrate is, when viewed normal to the etched surface of the glass substrate, located up to 50 μm from said etched surface, preferably up to 25 μm from said etched surface, more preferably up to 20 μm from said etched surface, most preferably between up to 20 μm and up to 10 μm from said etched surface.

15. The process according to claim 1, wherein, when present, the material or a derivative thereof incorporated within said glass substrate forms a gradient in terms of its frequency when moving from the etched surface normal to said etched surface.

16. The process according to claim 1, wherein step iv) further comprises sonication of the functionalized glass substrate and, preferably, following sonication of the functionalized glass substrate, the functionalized glass substrate is dried.

17. Use of the functionalized glass substrate manufactured according to the process of claim 1 in architectural, automotive or electronic applications, e.g. in a glazing frame, wall, bulkhead, blind, door, electronic device such as a PV module, liquid-crystal display or OLED, a touchscreen, mirror, container, furniture, splashback, vehicle window, energy storage glass, electrical connector, sensor, actuator, in magnetics, and/or spintronics.
